(19) United States
(12) Patent Application Publication
(10) Pub. No.: US 2010/0262961 A1
(43) Pub. Date: Oct. 14, 2010

(54) METHOD AND SYSTEM FOR DOWNLOADING SOFTWARE

(75) Inventors: Koo Yong Pak, Seoul (KR); Sung Hyun Cho, Seoul (KR); Il Gon Park, Seoul (KR); Min Gyu Chung, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/740,364

(22) PCT Filed: Oct. 17, 2008
(86) PCT No.: PCT/KR08/06147

§ 371 Date: Apr. 29, 2010

Related U.S. Application Data
(60) Provisional application No. 60/988,808, filed on Nov. 18, 2007.
(60) Provisional application No. 60/983,925, filed on Oct. 30, 2007.
(60) Provisional application No. 60/986,603, filed on Nov. 9, 2007.
(60) Provisional application No. 60/992,322, filed on Dec. 4, 2007.

(51) Int. Cl. G06F 9/44

(52) U.S. Cl. 717/173

(57) ABSTRACT

There is disclosed a method and system for downloading software. The software download method includes receiving a software file and metadata associated with the software file from a software originator, using the metadata for a notification service for notifying the availability of software, providing the notification service to a delivery network gateway or an IPTV terminal function of a consumer domain using a remote configuration and management server, preparing the software file so that the software file can be delivered over an IP network, and unicasting or multicasting the prepared software file to the gateway or the IPTV terminal function. When service software configuration or update of a device within a consumer domain is required at the time of an IPTV service, pertinent software can be downloaded onto the corresponding device.

### TECHNICAL FIELD

The present invention relates to a method and system for downloading software, and more particularly, to software download technologies in which software necessary for the configuration or update of a service module can be efficiently provided from an IPTV system to devices of a consumer domain.

### BACKGROUND ART

In recent years, digital TV services employing a wired or wireless communication network have been generalized. The digital TV services can provide a variety of services that could not be provided in existing analog broadcasting services. For example, an Internet protocol television (IPTV) service, i.e., a kind of the digital TV service provides interactivity in which a user can actively select the type of an audience program, the audience time, and so on. This IPTV service can also provide a variety of supplementary services, for example, Internet search, home shopping, online game and the like on the basis of such interactivity.

For this IPTV service, the user side must be equipped with an IPTV device. The IPTV device is a device including functions of receiving IPTV services and can include, for example, a settop box, etc. This IPTV device has software, which supports interactive services, installed therein and can play a role as a service client based on the software. For example, the IPTV device can request a service provider to transmit broadcast content while transmitting and receiving information to and from the service provider over an IP network, transform the broadcast signal, received from the service provider, into a standard TV signal, and transmit the TV signal to a TV receiver, i.e., a display device.

Further, fields for providing IPTV services have recently been expanded by associating this IPTV device with home network environment. For example, a domain, including IPTV devices and home network devices, can be configured and content provided from a service provider can be shared within the domain. In this case, IPTV content can be stored and played within a variety of devices wanted by users.

In order to efficiently operate IPTV services, devices within a user's domain must be managed stably on the server side. For instance, an IPTV system can be required to provide services in which a user's devices can be managed remotely using servers of a service stage. For this remote management service, system components should be defined and a variety of scenarios employing the components should be able to be presented. Accordingly, there is an urgent need for the development of technologies associated with corresponding fields.

### DISCLOSURE OF INVENTION

### Technical Problem

Accordingly, the present invention has been made in view of the above problems, and it is an object of the present invention to provide a method and system for downloading software in an IPTV system, in which software necessary for configuration or update can be provided from the IPTV system to devices of a consumer domain.

### Technical Solution

To achieve the above object, the present invention provides a software download method. The software download method includes the steps of receiving a software file and metadata associated with the software file from a software originator; using the metadata for a notification service for notifying the availability of software; providing the notification service to a delivery network gateway of a consumer domain or an IPTV terminal function of the consumer domain using a remote configuration and management server; preparing the software file so that the software file can be delivered over an IP network; and unicasting or multicasting the prepared software file to the delivery network gateway or the IPTV terminal function. The step of using the metadata can include using the metadata in order to add a new entry for the notification service.

The software download method can further include the steps of storing the received software file and the metadata associated with the software file; and using the metadata in formatting and packaging of the software file.

The software download method can further include the step of performing signaling with the delivery network gateway of consumer domain for download management using the remote configuration and management server.

Further, the software download method can further include the step of performing signaling with the IPTV terminal function for configuration and download management of the IPTV terminal function. The software download method can further include the step of performing signaling with the remote configuration and management server and transmitting and receiving the metadata.

The step of providing the notification service can include providing a uniform resource locator (URL) from which the software can be downloaded to the network gateway or the IPTV terminal function. Further, the preparation step performs at least one of fragmenting, adding header, and adding parameters compatible with a delivery format.

Meanwhile, to achieve the above object, an another aspect of the present invention provides a software download system. The software download system can include a software download server receiving a software file and metadata associated with the software file from a software originator, preparing the software file so that the software file can be delivered over an IP network, and delivering the prepared software file to a delivery network gateway of a consumer domain or an IPTV terminal function of the consumer domain; and a remote configuration and management server performing signaling with the software download server and providing a notification service for downloading the software to the delivery network gateway or the IPTV terminal function on the basis of the metadata.

The software download server can associate the remote configuration and management server and the metadata and also use the metadata in order to add a new entry for the notification service.

### ADVANTAGEOUS EFFECTS

As described above, according to the present invention, when it is necessary to configure or update service software of devices within a consumer domain at the time of IPTV services, pertinent software can be downloaded efficiently onto the corresponding devices.

### BRIEF DESCRIPTION OF THE DRAWINGS

FIG. 1 is a block diagram showing a system configuration for an IPTV service and shows an example in which an IPTV system is classified into logical domains;

FIG. 2 is a block diagram showing the configuration of a system related to remote device management of an IPTV system;

FIG. 3 is an exemplary view showing a connection relationship between a system configuration for providing software download service and respective components;

FIG. 4 is a flowchart showing a software download procedure in accordance with a preferred embodiment of the present invention;

FIG. 5 is an exemplary view showing an association operation between a CAS system and a DRM system;

FIG. 6 is a flowchart showing an association scenario of the CAS system and the DRM system using CMUI and RMI;

FIG. 7 is an exemplary view showing a scenario for delivering policy information to a device in an IPTV system;

FIG. 8 is an exemplary view showing another scenario for delivering policy information to a device in an IPTV system; and

FIG. 9 is an exemplary view showing a scenario for updating policy information in an IPTV system.

### DESCRIPTION OF REFERENCE NUMERALS OF PRINCIPAL ELEMENTS IN THE DRAWINGS

10: software download server
11: software storage
12: software download manager
13: distribution preparation module
14: unicast delivery module
15: multicast delivery module
20: remote configuration and management server
30: transport network
44: delivery network gateway
48: IPTV terminal function
60: software originator

### MODE FOR THE INVENTION

Hereinafter, the present invention will be described in detail in connection with preferred embodiments with reference to the accompanying drawings in order for those skilled in the art to be able to implement the invention. In the preferred embodiments of the present invention, specific technical terminologies are used for clarity of the content. However, It is to be understood that the present invention is not limited to specific selected terminologies and each specific terminology includes all technical synonyms operating in a similar way in order to accomplish a similar object.

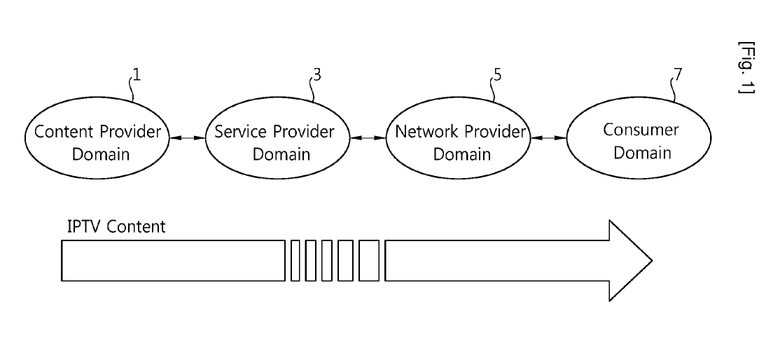

FIG. 1 is a block diagram showing a system configuration for an IPTV service and shows an example in which an IPTV system is classified into logical domains.

As shown in FIG. 1, the IPTV system can include a content provider domain 1, a service provider domain 3, a network provider domain 5, and a consumer domain 7. A system configuration of each of the domains can be implemented in various ways according to implementation environments. For example, each domain may include a plurality of systems (for example, servers, devices, networks, software modules, etc.) or a specific system may include a plurality of domains.

The content provider domain 1 can include at least one content provider. The content provider can be an entity that owns content or content assets or has a license for selling content or content assets. The content provider can provide content to service providers. In typical IPTV services, a substantial primary source with respect to consumers is a service provider, but the content providers and the consumers can be directly associated in order to manage and protect the rights of content under different circumstances.

The service provider domain 3 can include at least one service provider. The service provider can be an entity, which is provided with content or content assets from content providers and provides services to consumers. The service provider and the content provider may be managed and operated by the same service provider or different service providers.

The network provider domain 5 can include at least one network provider. The network provider can be an entity, for example, a delivery system that connects service providers and consumers for IPTV services. The delivery system can include an access network, a core or backbone network and the like using various network technologies. The network provider can provide a wired or wireless delivery system.

The consumer domain 7 can refer to a domain that consumes IPTV services. The consumer domain 7 can consist of a variety of entities. For example, the consumer domain may refer to an IPTV settop box, which can receive, store and render content and distribute content to home devices, in a narrow sense, but may include one or more home networks including an IPTV settop box, home devices, a network gateway and so on in a broad sense. Also the consumer domain may further include wireless devices such as mobile devices. In this case, entities within the consumer domain may share content, etc., which are provided from service providers. In the present embodiment, the consumer domain of a broad sense is illustrated.

The IPTV system can remotely manage devices within a consumer domain for effective services. Remote device management of the IPTV system can have a delivery network gateway (DNG) and an IPTV terminal function (ITF) device within a consumer domain as its management targets. Such remote device management can include software download, remote diagnostics, security management, status monitoring, provisioning of parameters and the like.

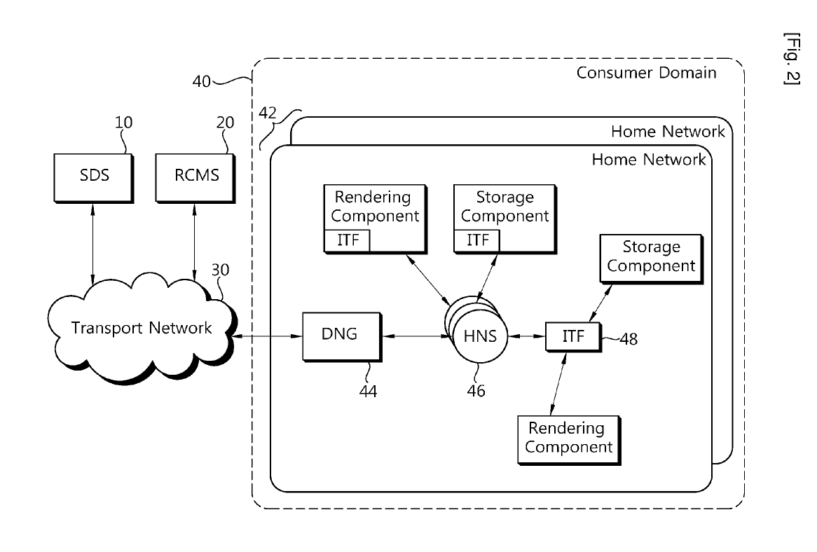

FIG. 2 is a block diagram showing the configuration of a system related to remote device management of the IPTV system.

As shown in FIG. 2, for remote device management, a software download server

(SDS) 10 and a remote configuration and management server (RCMS) 20 are equipped on the server side.

The software download server 10 downloads software, which is necessary for an initial configuration or update of a delivery network gateway (DNG) 44 or an IPTV terminal function (ITF) 48, onto the delivery network gateway 44 or the IPTV terminal function 48 via a transport network 30 under the control of the remote configuration and management server 20. The remote configuration and management server 20 can control and manage the above remote device management services, for example, software download, remote diagnostics, security management, status monitoring and the like.

Meanwhile, a consumer domain 40 is constructed on the user side. The consumer domain 40 can include at least one home network 42. The delivery network gateway 44, the IPTV terminal function 48, etc. are included in the home network 42.

The delivery network gateway 44 can perform a function of interfacing the home network 42 with an external IP communication network. For example, the delivery network gateway 44 can receive and process data transmitted via the transport network 30 from the external software download server 10 or the external remote configuration and management server 20 and transmits the processed data to a corresponding entity of the home network 42. The delivery network gateway 44 can also process data transmitted from entities within the home network 42 and transmit the processed data to the transport network 30. The delivery network gateway 44 may be an independent device or a function module included in an IPTV device, etc.

The IPTV terminal function 48 may refer to a module that performs a function of being provided with IPTV services. This IPTV terminal function 48 can operate in conjunct with a storage component for storing content and a rendering component for playing content. The IPTV terminal function 48 may be an independent device or software included in a storage component or a rendering component. A home network segment (HNS) 46 may be included between the IPTV terminal function 48 and the delivery network gateway 44.

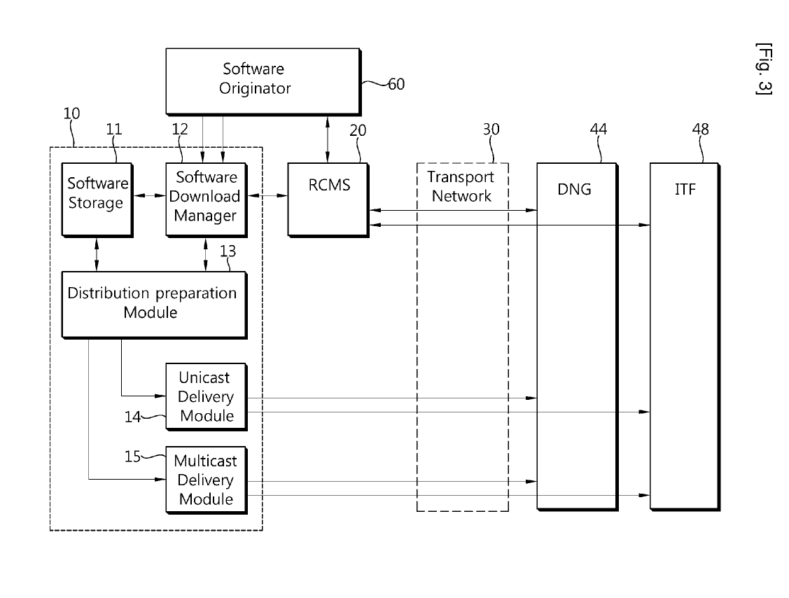

FIG. 3 is an exemplary view showing a connection relationship between a system configuration for providing software download service and respective components.

Referring to FIG. 3, the terminology ‘software download service’ can refer to a service in which software files pertinent to configuration or update are downloaded from the server to a corresponding entity in order to configure and update entities within the consumer domain, for example, the delivery network gateway 44, the IPTV terminal function 48, and so on. In the present invention, at the time of the software download service, the delivery network gateway 44 and the IPTV terminal function 48 can be considered as separate entities. Thus, download onto the delivery network gateway 44 differs from download onto the IPTV terminal function 48.

The software can include executable applications, modules, software images, profile files, content, etc., which are associated with IPTV services. It is preferred that such software can be downloaded onto the IPTV terminal function 48 or the delivery network gateway 44 and then executed without rebooting a corresponding device.

A software originator 60 can be a manufacturer or an independent software vendor within the delivery network gateway 44 or the IPTV terminal function 48. The software originator 60 can establish a business relationship with a provider that controls remote configuration and management, for example, the remote configuration and management server 20 playing a role as a network operator of the software download service. That is, the software originator 60 operates in conjunction with the remote configuration and management server 20 through a business interface. For example, the software originator 60 and the remote configuration and management server 20 can exchange pieces of information necessary for software download on the basis of a business cooperation relationship.

The remote configuration and management server 20 performs a function of controlling and managing software download. The remote configuration and management server 20 operates in conjunction with the software originator 60 through the business interface as mentioned above. Also, the remote configuration and management server 20 can perform signaling with the software download server 10 according to a protocol previously engaged with the software download server 10 in order to control the software download and exchange metadata, which is associated with a software file to be downloaded, with the software download server 10.

Meanwhile, the remote configuration and management server 20 can manage configuration and download of software while performing signaling with the delivery network gateway 44 or the IPTV terminal function 48. At this time, such signaling between the remote configuration and management server 20 and the delivery network gateway 44 or between the remote configuration and management server 20 and the IPTV terminal function 48 can be performed on the basis of TR069 (Technical Report069) or the like, i.e., a remote management standard of a digital subscriber line (DSL).

Further, the remote configuration and management server 20 may provide notification service to the delivery network gateway 44 or the IPTV terminal function 48 while operating in conjunction with the software download server 10.

The notification service can refer to service, notifying the delivery network gateway 44 or the IPTV terminal function 48 of the availability of software. For example, the remote configuration and management server 20 can notify the delivery network gateway 44 or the IPTV terminal function 48 of software to be downloaded, update software, and so on or ask the delivery network gateway 44 or the IPTV terminal function 48 about its update intention.

At this time, the remote configuration and management server 20 may provide the delivery network gateway 44 or the IPTV terminal function 48 with access information of a server (that is, the software download server 10), which can download a corresponding software file. For example, the remote configuration and management server 20 can provide a uniform resource locator (URL) or URL list of a server, which can download corresponding software thereon, as the delivery network gateway or the IPTV terminal function at the time of the notification service.

Further, the remote configuration and management server 20 can be provided with metadata of software from the software download server 10 for the notification service and can notify the delivery network gateway 44 or the IPTV terminal function 48 of at least part of the metadata at the time of the notification service.

The software download server 10 receives and stores a software file and its associated metadata from the software originator 60 while operating in conjunction with the remote configuration and management server 20 under the control of the remote configuration and management server 20, processes the software file and its associated metadata suitably for delivery, and delivers the processed results to the delivery network gateway 44 or the IPTV terminal function 48 in a unicast or multicast way. The software download server 10 can refer to a logical entity, including components necessary for software download service. The components within the software download server 10 are preferably colocated physically, but are not limited. The software download server 10 can be included in a service provider domain, a network provider domain or the like.

This software download server 10 can include components such as a software download manager 12, a software storage 11, a distribution preparation module 13, a unicast delivery module 14, and a multicast delivery module 15.

The software download manager 12 coordinates reception and storage of a software file and metadata associated with the software file. The metadata may be used to add a new entry for the notification service and may be used in formatting or packaging of a software file by the distribution preparation module.

This software download manager 12 can perform signaling with the remote configuration and management server 20 according to a preset protocol and exchange metadata with the remote configuration and management server 20. Further, the software download manager 12 can receive a software file, including specific software, and metadata associated with the software file, from the software originator 60 and store them in the software storage 11.

The software storage 11 provides a storage space capable of consistently storing software received from the software originator 60. The distribution preparation module 13 can perform a preparation function for delivering the software file via an IP network. The preparation function can include fragmenting, adding header, adding parameters compatible with a delivery format and the like. A software file prepared by the distribution preparation module 13 is delivered to the delivery network gateway 44 or the IPTV terminal function 48 by the unicast delivery module 14 or the multicast delivery module 15.

The unicast delivery module 14 provides a unicast delivery function, which enables delivery by onetoone correspondence to be carried out between the software download server 10, i.e., a data source and a delivery network gateway 44, i.e., a sink point or the IPTV terminal function 48, so that it can deliver a software file to the delivery network gateway 44 or the IPTV terminal function 48. The multicast delivery module 15 provides a multicast delivery function, which enables delivery by 1:N correspondence to be performed between the software download server 10, i.e., a data source and a sink point, so that it can deliver a software file to the delivery network gateway 44 or the IPTV terminal function 48.

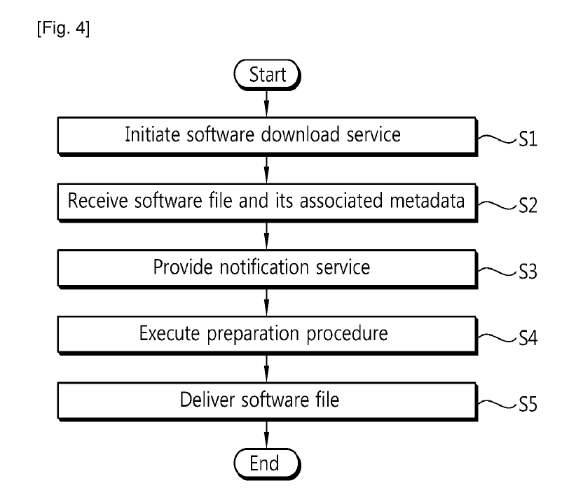

FIG. 4 is a flowchart showing a software download procedure in accordance with a preferred embodiment of the present invention and shows a procedure of downloading software onto the IPTV terminal function 48 of the consumer domain.

Referring to FIGS. 3 and 4, first, a software download service can be initiated from any one of the software originator 60, the remote configuration and management server 20, and the IPTV terminal function 48 (step: S1).

For example, in the case in which it is necessary to download software onto the IPTV terminal function 48 while communicating with the software originator 60 and the IPTV terminal function 48, the remote configuration and management server 20 can initiate the software download service by controlling the software download server 10. Meanwhile, in the case in which a new software or software update for IPTV services is required, the software originator 60 can request the remote configuration and management server 20, having a business relationship with the software originator 60, to download software onto the IPTV terminal function 48, or in the case which download of specific software is required while communicating with the remote configuration and management server 20, the IPTV terminal function 48 can request the software download service from the remote configuration and management server 20. In this case, the remote configuration and management server 20 can control the software download server 10 in response to the request.

For such software download, the remote configuration and management server 20 can control the software download server 10 while performing signaling with the software download server 10 according to a preset protocol. Further, the remote configuration and management server 20 can manage download of software while performing signaling with the IPTV terminal function 48 according to a preset protocol.

First, the remote configuration and management server 20 requests the software download server 10 to download specific software. At this time, the remote configuration and management server 20 can provide the software download server 10 with identification information of the corresponding software. In response to the request, the software download server 10 can receive a software file, including the corresponding software, and metadata associated with the software file from the software originator 60 and store them (step: S2).

The software download server 10 can use the metadata in order to add a new entry for notification service. For example, in the case in which information necessary for the notification service is requested from the remote configuration and management server 20, the software download server 10 can use the metadata to provide corresponding information. For example, the software download server 10 can provide at least part of the metadata to the remote configuration and management server 20.

The remote configuration and management server 20 can provide the notification service to the IPTV terminal function 48 on the basis of the metadata (step: S3). As mentioned above, the notification service can include a service notifying the availability of software. For example, the remote configuration and management server 20 can notify the IPTV terminal function 48 that software will be downloaded or ask a download intention of the IPTV terminal function 48. If the IPTV terminal function 48 rejects download of corresponding software, the software download procedure may be stopped.

Meanwhile, the remote configuration and management server 20 can provide a URL or URL list of a server, which can download corresponding software, as the delivery network gateway or the IPTV terminal function at the time of the notification service. This notification service may be carried out on the basis of a protocol defined between the remote configuration and management server 20 and the IPTV terminal function 48, for example, TR069 or the like.

The software download server 10 performs a preparation procedure for distributing stored the software file over an IP network (step: S4). For example, the software download server 10 can perform fragmenting, adding header, adding parameters compatible with a delivery format and the like. When the preparation procedure is completed, the software download server 10 delivers the prepared software file to the IPTV terminal function 48 in a unicast or multicast way (step: S5). Accordingly, the IPTV terminal function 48 can download the software.

The software download procedure of downloading software onto the IPTV terminal function 48 has been described above. As described above, software download can be controlled by the remote configuration and management server 20 and performed by the software download server 20. It is preferred that data delivered upon software download be authenticated by the remote configuration and management server 20. Meanwhile, in the case in which software is downloaded onto the delivery network gateway 44, the above software download procedure can be performed as the same concept.

On the other hand, for the purpose of stable and reliable services of an IPTV system, it is required that IPTV content be able to be protected safely. To this end, when delivering content from the service provider domain to the consumer domain, the content can be protected using a service protection system, for example, a conditional access system (CAS). The content delivered to the consumer domain can be stored and rendered through an IPTV receiving device, for example, an IPTV settop box and redistributed to home devices, so the content can be shared within the consumer domain. In order for content to be shared safely within the consumer domain, a content protection system, for example, a digital rights management (DRM) system can be used. Accordingly, a smooth association structure between a service protection system and a content protection system is necessary.

Hereinafter, an embodiment related to association between a service protection system and a content protection system is described. In the following embodiment, it is assumed that the service protection system is a CAS system and the content protection system is a DRM system.

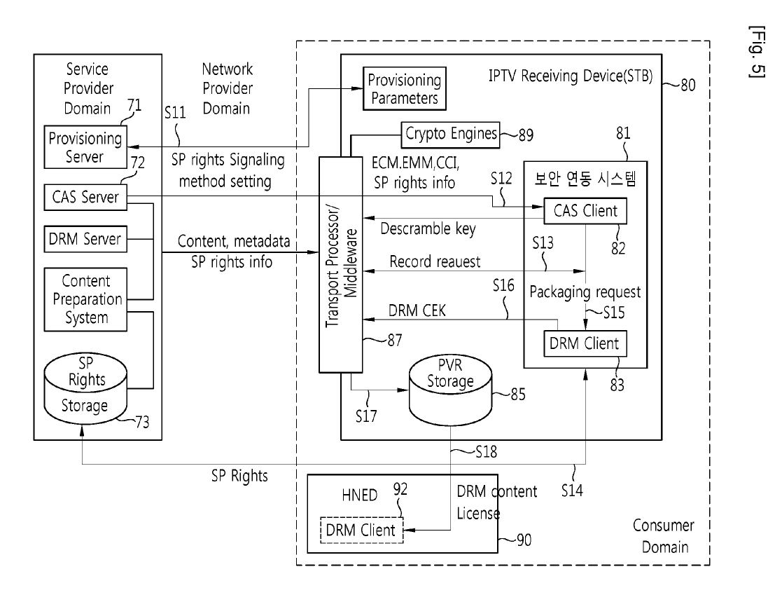

FIG. 5 is an exemplary view showing an association operation between the CAS system and the DRM system.

As shown in FIG. 5, first, a provisioning server 71 of the service provider domain sets provisioning parameters while operating in conjunction with an IPTV receiving device 80 according to a preset protocol (step: S11). For example, a service provider can set and authenticate a signing method of service provider (SP) rights information through a provisioning protocol (SetParameterValues RPC) such as TR069 of a DRL or the like.

Next, a CAS function is performed through association between a CAS server 72 and a CAS client 82. Serviced content is protected and protection of serviced content is released through an entitlement control message (ECM), an entitlement management message (EMM), copy control information (CCI) or the like (step: S12). Next, if there is a request for content from a middleware 87 (step: S13), a security association system 81 can acquire service provider (SP) rights through a specific channel using the service provider rights information (step: S14). For example, in the case in which the security association system 81 has been provided with the service provider rights information in an URL information form, the security association system 81 can acquire service provider rights by accessing a service provider (SP) rights storage 73 through, for example, an OOB channel.

In the case in which content storage rights is assigned to the acquired service provider rights, the security association system 81 requests DRM packaging from a DRM client 83 (step: S15). The DRM client 83 transfers a content encryption key (CEK), necessary for the packaging, to a crypto engine 89 and requests the crypto engine 89 to encrypt the content (step: S16).

After the crypto engine 89 performs the task requested by the DRM client 83, a personal video recorder (PVR) storage 85 stores the encrypted content (step: S17). Thus, the security association system 81 can redistribute the encrypted content, which is stored in the PVR storage 85, to a home device 90 (step: S18). At this time, if a DRM client 92 of the home device 90 is a different kind of DRM from the DRM client 83 of the security association system 81, the security association system 81 can redistribute the content using a DRM interoperable system, or download the same DRM client onto the home device 90 and then redistribute the content.

Meanwhile, in the abovementioned embodiment, a scenario in which the service provider side provides service provider rights information and service provider rights is acquired through a specific channel on the basis of the service provider rights information has been described. However, information pertinent to management, usage, and rights of content can be defined in various forms and delivered and processed in various ways. Hereinafter, the concepts of content management/usage information (CMUI) and rights management information (RMI) are defined, and formats and processing scenarios thereof are described.

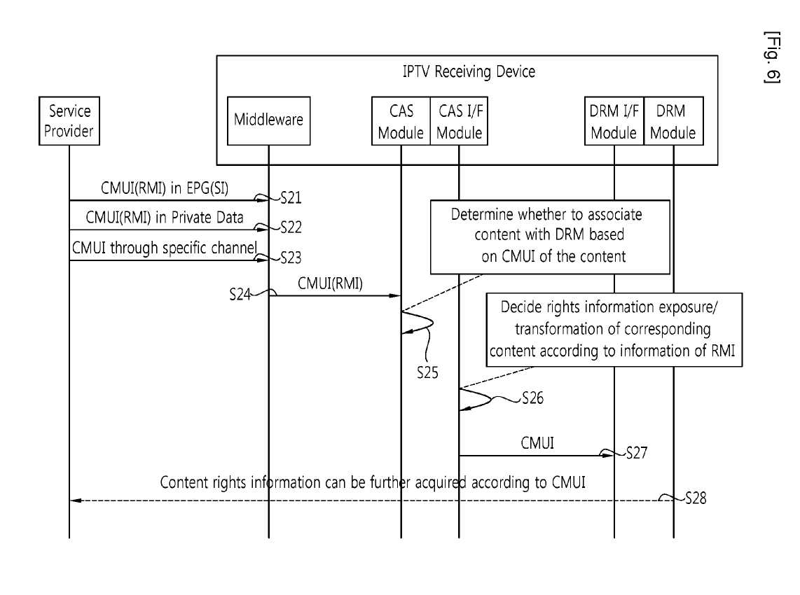

FIG. 6 is a flowchart showing an association scenario of the CAS system and the DRM system using CMUI and RMI.

As shown in FIG. 6, first, a service provider can transfer CMUI and RMI to an IPTV receiving device (S21 or S22 or S23). The CMUI can refer to content metadata having management and usage information about content. The RMI can refer to content metadata having rights information of content. Detailed structures of the CMUI and RMI are described in detail later on.

The service provider may transfer the CMUI or RMI to the IPTV receiving device as an electronic program guide (EPG) or a descriptor of service information (SI) (step: S21), transfer the CMUI or RMI to the IPTV receiving device through a private data area of the CA system (step: S22) or directly transfer the CMUI or RMI to the IPTV receiving device through a specific channel (step: S23).

The transferred CMUI and RMI experience an integrity verification and certification process for the purpose of security and are then transferred to a CAS module (step: S24). The CAS module can control use of corresponding content and determine an association method with a DRM module on the basis of the CMUI information (step: S25). A CAS interface (I/F) module decides delivery and transformation of rights information on the basis of RMI of content to be associated therewith (step: S26).

If the CMUI is delivered from the CAS I/F module to a DRM I/F module, the DRM I/F module can provide the CMUI to a DRM module (step: S27). The DRM module can use the received CMUI basic information for content management and usage. The DRM module may further acquire content rights information while communicating with the service provider, if needed (step: S28).

The CMUI can include the following fields.
“length”: indicates the byte number subsequent to a “length” field within the CMUI structure.
“Viewable”: indicates whether content is viewable.
“View Control”: indicates control information about content view. It can have values and meanings as listed in Table 1.

TABLE 1

| Value | Meaning |
|---|---|
| 0x0 | Not controlled - free |
| 0x1 | Period |
| 0x2 | Count |
| 0x3 | Period + Count |
| 0x4 | Domain |
| 0x5 | Period + Domain |
| 0x6 | Count + Domain |
| 0x7 | Period + Count + Domain |

“storable”: indicates whether content can be stored.
“Store Control”: indicates control information (based on CCI) about content storage. It can have values and meanings as listed in Table 2.

TABLE 2

| Value | Meaning |
|---|---|
| 0x0 | Not controlled - free (CCNA) |
| 0x1 | Only Once (C1) |
| 0x2 | One Generation (C1G) |
| 0x3 | No More (CNM) |
| 0x4 | Never (CN) with Zero Retention Not Asserted |
| 0x5~0x7 | User-Defined |

“distributable”: indicates whether content can be distributed.
“distribute control: indicates control information about content distribution. It can have values and meanings as listed in Table 3.

TABLE 3

| Value | Meaning |
|---|---|
| 0x0 | Not controlled - free |
| 0x1 | Authorized Domain |
| 0x2 | CAS-DRM |
| 0x3 | AD + CAS-DRM |
| 0x4 | Area |
| 0x5 | |
| 0x6 | |
| 0x7 | |

“outputable”: indicates whether content can be output to a content output terminal.

It is necessary to be distinguished from a content view function.
“output control”: indicates control information about the output to the content output terminal. It can have values and meanings as listed in Table 4.

TABLE 4

| Value | Meaning |
|---|---|
| 0x0 | Not controlled - free |
| 0x1 | Digital Output |
| 0x2 | Analog Output |
| 0x3 | DO + AO |
| 0x4 | Output with Content Protection |
| 0x5 | DO with CP |
| 0x6 | AO with CP |
| 0x7 | DO + AO with CP |

“derivative”: indicates whether content can be changed secondarily. It is necessary to be distinguished from a content storage function.
“derivative control”: indicates a secondary change of content. It can have values and meanings as listed in Table 5.

TABLE 5

| Value | Meaning |
|---|---|
| 0x0 | Not controlled - free |
| 0x1 | DRM Needed |
| 0x2 | Domain |
| 0x3 | DRM + Domain |
| 0x4 | Common License Attached |
| 0x5 | |
| 0x6 | |
| 0x7 | |

“secure_clock_option”: indicates a security clock option for content protection. It can have values and meanings as listed in the following Table 6.

TABLE 6

| Value | Meaning |
|---|---|
| 0x0 | Not controlled - free |
| 0x1 | Device RTC |
| 0x2 | Remote RTC |
| 0x3 | Transport RTC |

“view_start_date”: indicates the start date of content view.
“view_end_date”: indicates the end date of content view.
“view_count”: indicates the view count of content.
“view_domain_id”: indicates a domain identifier for content view.
“view_domain_entry_point_length”: indicates the name length of a domain entry point for content view.
“view_domain_entry_point_byte”: indicates the configuration byte of the name of a domain entry point for content view.
“distribute_domain_id”: indicates a domain identifier for content distribution.
“distribute_domain_entry_point_length”: indicate the name length of a domain entry point for content distribution.
“distribute_domain_entry_point_byte”: indicates the configuration byte of the name of a domain entry point for content distribution.
“content_transformable”: indicates whether content can be transformed.
“right_transformable”: indicates whether rights information can be transformed.
“area_id or area_information”: indicates an area identifier or specific area information.
“derivative_domain_id”: indicates a domain identifier for secondary change of content.
“derivative_domain_entry_point_length”: indicates the length of a name of a domain entry point for secondary change of content.
“derivative_domain_entry_point_byte”: indicates the configuration byte of the name of a domain entry point for secondary change of content.
“secure_clock_entry_point_length”: indicates the length of a name of a security clock entry point (for example, a remote time server)
“secure_clock_entry_point_byte”: indicates the configuration byte of the name of a security clock entry point.
“enable_revocaton”: indicates whether a revocation function with respect to content is possible.
“revocation_entrypoint”: indicates an entry point for revocation management.
“remote”: indicates whether content is nPVR or remote management content.
“remote_entrypoint”: indicates a content access entry point for nPVR or remote management.

Meanwhile, the field configuration of the RMI can be listed as the following Table 7.

TABLE 7

| Syntax | Bit number | Type |
|---|---|---|
| Right_Management_Information( ){ | | |
| length | 8 | uimsbf |
| content_identifier_length | 8 | uimsbf |
| for (i=0; i<content_identifier_length; i++){ | | |
| content_identifier_byte | 8 | uimsbf |
| } | | |
| exportable | 1 | bslbf |
| downscalable | 1 | bslbf |
| upscalable | 1 | bslbf |
| } | | |

Fields included in the RMI are as follows.
“length”: indicates the byte number subsequent to a “length” field within Right_Management_Information structure.
“content_identifier_length”: indicates the byte number of “content_identifier_byte”.
“content_identifier_byte”: indicates a content identifier byte.
“exportable”: indicates whether content rights information is exportable.
“downscalable”: indicates whether content rights information is downscalable.
“upscalable”: indicates whether content rights information is scalable.

Hereinafter, a scenario for acquiring policy information when security association operation in a device is described. If a security association module, for example, a CASDRM association module is installed at a device, the device can receive a policy parameter value provided from a policy information provider.

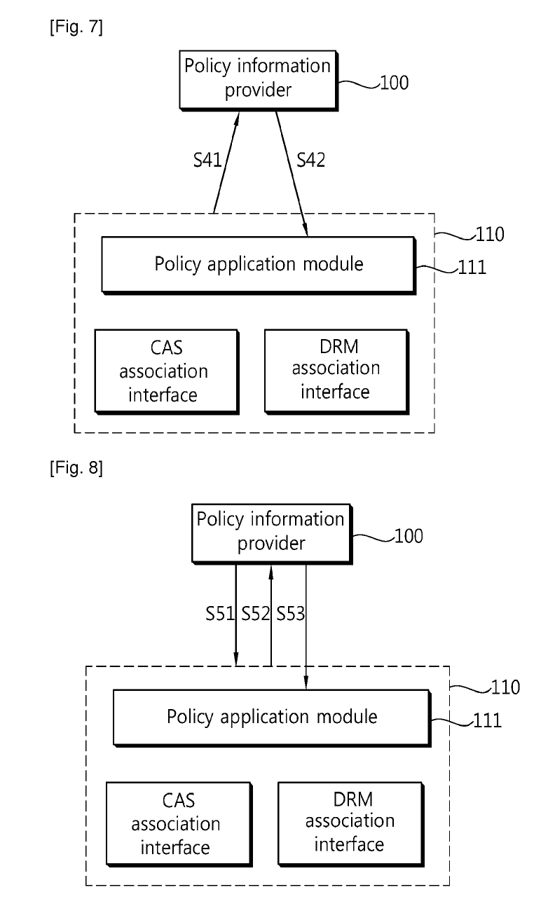

FIG. 7 is an exemplary view showing a scenario for delivering policy information to a device in an IPTV system.

As shown in FIG. 7, first, a device 110 at which a CASDRM association module is installed checks configuration information of a corresponding association module. At this time, the device 110 can create a list of a module, an interface, and an object in which policy parameters, such as capability information, need to be set.

Next, the device 110 can request the delivery of a policy parameter value by calling a policy information providing interface of a policy information provider 100 based on information listed in the created list (step: S41). At this time, the device 110 can use an URL of the policy information provider 100, which has been defined when initially installing the CASDRM association module.

The policy information provider 100 includes a policy parameter value, which corresponds to a requested module, interface or object in which policy parameters, such as capability information, need to be set, in a response of the policy information providing interface and sends the policy parameter value to the device 110 (step: S42). Accordingly, a policy application module 111 of the device 110 can receive and use the policy parameter value.

Meanwhile, if an operation policy of a service provider is changed although an initial set value has been normally applied as described above, policy information can be updated using an update interface.

FIG. 8 is an exemplary view showing another scenario for delivering policy information to a device in an IPTV system.

As shown in FIG. 8, when a device 110 having a CASDRM association module installed therein is disposed in a service area, a policy information provider 100 recognizes this fact and requests setting information from the device 110 in order to check components, such as a module, an interface, and capability information, which are owned by the corresponding device 110 (step: S51).

The device 110 that has received the request information sends its configuration information to the policy information provider 100 in response to the corresponding request (step: S52). The policy information provider 100 that has received the relay information selects only portions in which a policy parameter value needs to be set from the configuration information provided from the device 110 and delivers a policy information value of the corresponding device 110 by calling a client policy information update interface (step: S53). Accordingly, a policy application module 111 of the device 110 can receive and use the policy parameter value.

Meanwhile, in the case in which configuration information of the a device 110 or the policy of a service provider is changed during a service operation, a policy set value can be delivered to the device 110 according to a policy information update procedure to be described below.

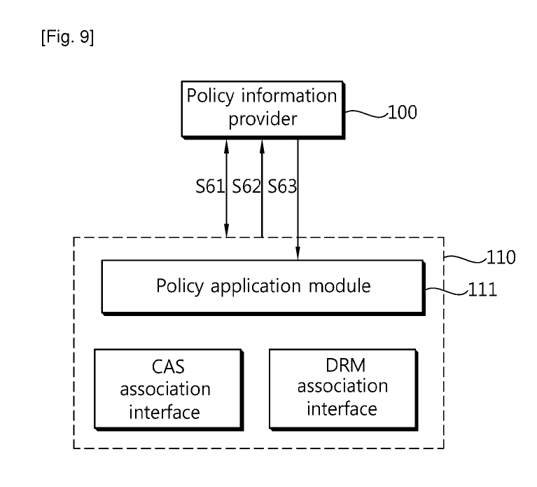

FIG. 9 is an exemplary view showing a scenario for updating policy information in an IPTV system.

As shown in FIG. 9, when a device 110 is disposed in a service area, an original policy information provider 100 performs an event subscription procedure for receiving changed configuration information of the corresponding device 110 (step: S61).

Next, when configuration information of the device 110 is changed during a service operation, the device 110 can provide newly added or deleted configuration information to the policy information provider 100 using an event (step: S62). The policy information provider 100 can check the added or deleted configuration information of the device 110 and deliver a policy parameter value, which will be applied newly, to the device 110 (step: S63). Accordingly, a policy application module 111 of the device 110 can use a corresponding policy parameter value.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A software download method, comprising the steps of:
receiving a software file and metadata associated with the software file from a software originator;
using the metadata for a notification service for notifying the availability of software;
providing the notification service to a delivery network gateway of a consumer domain or an IPTV terminal function of the consumer domain using a remote configuration and management server;
preparing the software file so that the software file can be delivered over an IP network; and
unicasting or multicasting the prepared software file to the delivery network gateway or the IPTV terminal function.

2. The software download method of claim 1, wherein the step of using the metadata includes using the metadata in order to add a new entry for the notification service.

3. The software download method of claim 1, further comprising the steps of:
storing the received software file and the metadata associated with the software file; and
using the metadata for formatting and packaging of the software file.

4. The software download method of claim 1, further comprising the step of performing signaling with the delivery network gateway of a consumer domain for download management using the remote configuration and management server.

5. The software download method of claim 1, further comprising the step of performing signaling with the IPTV terminal function for configuration and download management of the IPTV terminal function.

6. The software download method of claim 1, further comprising the step of performing signaling with the remote configuration and management server and transmitting and receiving the metadata.

7. The software download method of claim 1, wherein the step of providing the notification service includes providing a uniform resource locator (URL) from which the software can be downloaded to the network gateway or the IPTV terminal function.

8. The software download method of claim 1, wherein the preparation step performs at least one of fragmenting, adding header, and adding parameters compatible with a delivery format.

9. A software download system, comprising:
a software download server receiving a software file and metadata associated with the software file from a software originator, preparing the software file so that the software file can be delivered over an IP network, and delivering the prepared software file to a delivery network gateway of a consumer domain or an IPTV terminal function of the consumer domain; and
a remote configuration and management server performing signaling with the software download server and providing a notification service for downloading the software to the delivery network gateway or the IPTV terminal function on the basis of the metadata.

10. The software download system of claim 9, wherein the software download server associates the remote configuration and management server and the metadata and uses the metadata in order to add a new entry for the notification service.
